(19) United States
(12) Patent Application Publication
(10) Pub. No.: US 2006/0221815 A1
(43) Pub. Date: Oct. 5, 2006

(54) Failure-monitoring program and load-balancing device

(75) Inventor: Tsuyoshi Matsumoto, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/175,851

(22) Filed: Jul. 6, 2005

(30) Foreign Application Priority Data
Mar. 31, 2005 (JP) 2005-101161

(51) Int. Cl. H04J 1/16

(52) U.S. Cl. 370/216

(57) ABSTRACT

In a method for monitoring servers including destination servers for failure: definition-for-monitoring information including servers to be monitored, a monitoring procedure including a definition of a monitoring packet used in diagnosis of the servers to be monitored, and a criterion for determining normality of the servers to be monitored is generated and stored for each destination server; the monitoring packet is transmitted to each server to be monitored, in accordance with the definition-for-monitoring information; and it is determined that the server to be monitored is faulty and delivery of request packets to one of the destination servers corresponding to the server to be monitored is not allowed, when no response is returned from the server to be monitored, or when a response packet received from the server to be monitored does not satisfy the criterion.

### CROSS-REFERENCE TO RELATED APPLICATIONS

This application is based upon and claims the benefits of priority from the prior Japanese Patent Application No. 2005-101161, filed on Mar. 31, 2005, the entire contents of which are incorporated herein by reference.

### BACKGROUND OF THE INVENTION

1) Field of the Invention

The present invention relates to a failure-monitoring program and a load-balancing device for monitoring servers for a failure, and balancing load imposed on servers by distributing request packets from clients among the servers.

2) Description of the Related Art

In recent years, in order to ensure data processing capacity of servers and prevent lowering of responsibility caused by access concentration in the network systems having increasing variety and complexity, the load-balancing technology has become essential.

FIG. 17 is a diagram illustrating an example of a conventional load-balancing system. In the load-balancing system of FIG. 17, a load-balancing device 910 is arranged between the clients 921 and 922 and the servers 1, 2, and 3 (931, 932, and 933), and the load-balancing device 910 and the clients 921 and 922 are connected through a network 940. The load-balancing device 910 distributes request packets from the clients 921 and 922, among the servers 1, 2, and 3 (931, 932, and 933). The servers 1 and 2 (931 and 932) are HTTPS (HyperText Transfer Protocol Security) servers, which perform SSL (Secure Socket Layer) processing and HTTP (HyperText Transfer Protocol) processing. The server 3 (933) is an SSL accelerator, which performs SSL processing. The server 4 (933) is an HTTP server, which performs HTTP processing. Thus, the servers 3 and 4 (933 and 934) cooperate to perform processing similar to each of the servers 1 and 2 (931 and 932).

The load-balancing device 910 monitors the servers 1, 2, and 3 (931, 932, and 933) for failure, and does not deliver a client's request packet to a server which is determined to be faulty. The servers 1, 2, and 3 (931, 932, and 933) are monitored by transmitting monitoring packets from the load-balancing device 910 to the servers 1, 2, and 3 (931, 932, and 933), and determining whether or not each server is faulty on the basis of whether or not the server returns a response. For diagnosis, operations corresponding to respective protocol layers, such as ping-monitoring (diagnosis in the IP layer), syn-monitoring (diagnosis using a connection request in the TCP layer), and application monitoring (diagnosis of packets in the application layer), are performed.

In a load-balancing system which is proposed, for example, in Japanese Unexamined Patent Publication No. 2002-271371 (Paragraph Nos. <0011> to <0022> and FIG. 1), a load-balancing device and servers are connected through routers, and a plurality of packet transmission paths are determined between the load-balancing device and the servers by confirming not only whether or not packets can be normally transmitted between the load-balancing device and the routers, but also whether or not packets can be normally transmitted to the servers through the plurality of packet transmission paths containing the routers.

However, according to the conventional techniques for monitoring a load-balancing system for failure, it is difficult to monitor for failure a server located behind a server to which packets are to be delivered. Hereinafter, servers to which packets are delivered by a load-balancing device are referred to as destination servers.

In recent years, an accelerator for speeding up a specific processing function is added to a server in an increasing number of systems. In the case where SSL communication is performed, sometimes a server 3 (933) which performs SSL processing is arranged in the stage preceding the server 4 (934) which performs application processing such as HTTP processing, i.e., between the load-balancing device 910 and the server 4 (934), as illustrated in FIG. 17. Therefore, when viewed from the load-balancing device 910, the server 4 (934) is located behind the server 3 (933) to which packets are delivered.

However, in the conventional techniques for monitoring for failure, a one-to-one relationship is defined between a server which is to be monitored for failure and a server to which packets are to be delivered. In this case, only the server 3 (933) is defined as the server which is to be monitored for failure, and the load-balancing device 910 exchanges monitoring packets with only the server 3 (933). Therefore, it is impossible to monitor for failure the server 4 (934), which is located behind the server 3 (933).

In particular, according to the conventional techniques, failure in a server to which packets are to be delivered is determined on the basis of only whether or not a response to a monitoring packet transmitted from the load-balancing device is returned. For example, when the server 3 (933) is normal and the server 4 (934) is faulty in the construction of FIG. 17, it is impossible to return a normal response in the application layer. However, since the monitoring for failure is performed on the basis of only the response to the monitoring packet, the server to which packets are to be delivered is determined to be normal as long as the response is returned from the server 3 (933).

As explained above, since, according to the conventional failure-monitoring techniques, the monitoring packets are exchanged only between the load-balancing device and the destination servers, it is impossible to monitor for failure the servers located behind the destination servers.

### SUMMARY OF THE INVENTION

The present invention is made in view of the above problems, and the object of the present invention is to provide a failure-monitoring method and a load-balancing device which enable monitoring for failure a server connected to and located behind another server to which a packet is to be delivered.

In order to accomplish the above object, a failure-monitoring method for monitoring destination servers for failure in order to deliver request packets from clients to the destination servers and balance loads imposed on the destination servers is provided. The failure-monitoring method comprises: the steps of: (a) generating and storing for each of the destination servers definition-for-monitoring information in which one or more servers to be monitored, a monitoring procedure including a definition of a monitoring packet used in diagnosis of the one or more servers to be monitored, and, when necessary, a criterion for determining normality of the one or more servers to be monitored are defined; (b) transmitting the monitoring packet defined in the monitoring procedure to each of the one or more servers to be monitored, in accordance with the definition-for-monitoring information; and (c) determining that the server to be monitored is faulty and delivery of one or more request packets to one of the destination servers corresponding to the server to be monitored is not allowed, when no response is returned from the server to be monitored, or when a response packet received from the server to be monitored does not satisfy the criterion.

In addition, in order to accomplish the aforementioned object, a load-balancing device for delivering request packets from clients to destination servers so as to balance loads imposed on the destination servers, and monitoring the destination servers for failure is provided. The load-balancing device comprises: a definition-management unit which generates destination information in which the destination servers are defined as servers to which the request packets from the clients are to be delivered, generates definition-for-monitoring information for each of the destination servers, and manages the destination information and the definition-for-monitoring information, where one or more servers to be monitored, a monitoring procedure including a definition of a monitoring packet used in diagnosis of the one or more servers to be monitored, and, when necessary, a criterion for determining normality of the one or more servers to be monitored are defined in the definition-for-monitoring information; a failure-monitoring unit which transmits the monitoring packet defined in the monitoring procedure to each of the one or more servers to be monitored, in accordance with the definition-for-monitoring information, determines that each of the one or more servers to be monitored is faulty and delivery of one or more request packets to one of the destination servers corresponding to the server to be monitored is not allowed, when no response is returned from the server to be monitored, or when a response packet received from the server to be monitored does not satisfy the criterion, and determines that delivery of one or more request packets to one of the destination servers corresponding to each of the one or more servers to be monitored is allowed when the response packet received from the server to be monitored satisfies the criterion; and a delivery unit which delivers a request packet from a client to one of the destination servers to which delivery of one or more request packets is determined to be allowed, when the request packet is received from the client.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

FIG. 1 is a conceptual diagram illustrating the present invention which is realized in an embodiment.

FIG. 2 is a block diagram illustrating a construction of a client-server system in which a load-balancing device according to the embodiment of the present invention is arranged.

FIG. 3 is a diagram illustrating an example of a hardware construction of the load-balancing device according to the embodiment of the present invention.

FIG. 4 is a block diagram illustrating main processing flows in a first failure-monitoring method.

FIG. 5 is a diagram illustrating an example of a failure-monitoring table used in the first failure-monitoring method.

FIG. 6 is a sequence diagram illustrating a sequence of failure-monitoring processing in the first failure-monitoring method.

FIG. 7 is a flow diagram illustrating the failure-monitoring processing in the first failure-monitoring method.

FIG. 8 is a block diagram illustrating main processing flows in a second failure-monitoring method.

FIG. 9 is a diagram illustrating an example of a failure-monitoring table used in the second failure-monitoring method.

FIG. 10 is a sequence diagram illustrating a sequence of failure-monitoring processing in the second failure-monitoring method.

FIG. 11 is a flow diagram illustrating the failure-monitoring processing in the second failure-monitoring method.

FIG. 12 is a block diagram illustrating main processing flows in a third failure-monitoring method.

FIG. 13 is a diagram illustrating the structures of portions, corresponding to the TCP layer and the SSL layer, of a packet in accordance with the HTTPS protocol.

FIG. 14 is a sequence diagram illustrating a sequence of failure-monitoring processing in the third failure-monitoring method.

FIG. 15 is a flow diagram illustrating the failure-monitoring processing in the third failure-monitoring method.

FIG. 16 is a flow diagram illustrating processing performed by a destination server according to the embodiment.

FIG. 17 is a diagram illustrating an example of a conventional load-balancing system.

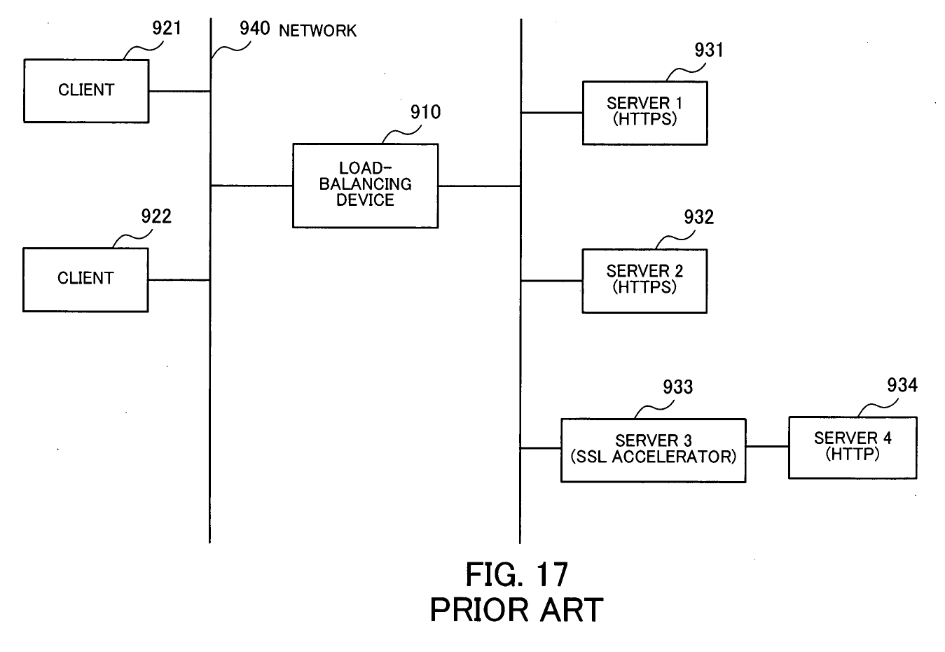

### DESCRIPTION OF THE PREFERRED EMBODIMENTS

The embodiment of the present invention is explained below with reference to drawings.

Outline of the Present Invention

First, an outline of the present invention which is realized in the embodiment is indicated, and thereafter details of the embodiment are explained.

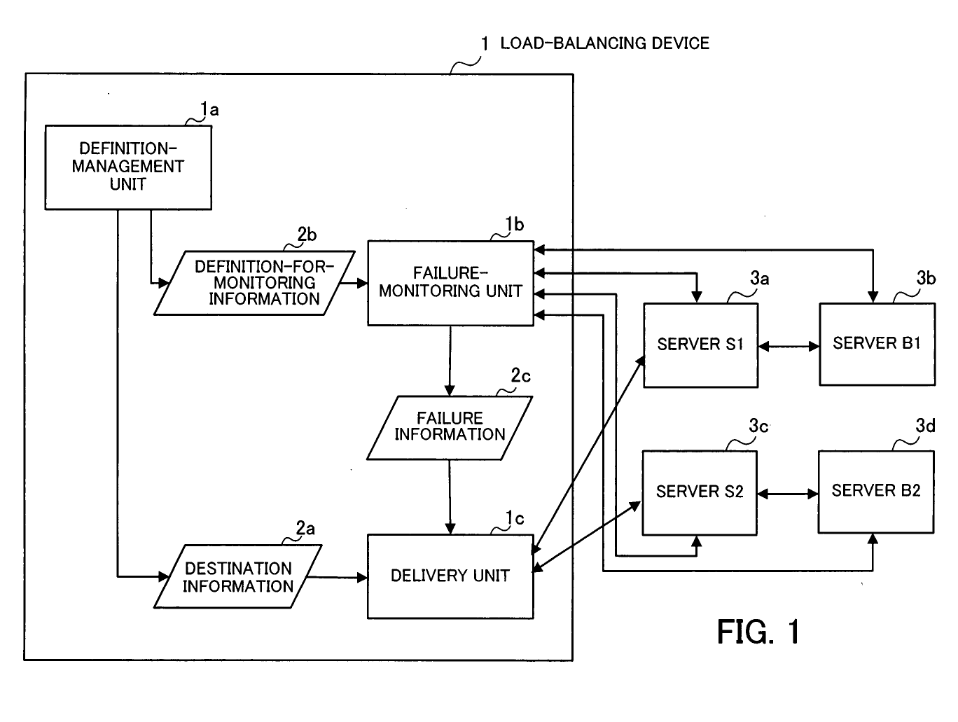

FIG. 1 is a conceptual diagram illustrating the present invention which is realized in the embodiment. The load-balancing device 1 according to the present invention comprises a definition-management unit 1a, a failure-monitoring unit 1b, and a delivery unit 1c. When request packets from clients (not shown) are inputted into the load-balancing device 1, the load-balancing device 1 distributes the request packets among servers so as to balance the load imposed on the servers.

In the configuration of FIG. 1, the combination of the server S1 (3a) and the server B1 (3b) realizes a predetermined processing function, i.e., the server S1 (3a) and the server B1 (3b) cooperate to realize the predetermined processing function. For example, the server S1 (3a) is an SSL accelerator, and the server B1 (3b) is an HTTP server. That is, the server S1 (3a) performs SSL processing, and the server B1 (3b) performs HTTP application processing. Therefore, request packets from clients are transmitted through the server S1 (3a) to the server B1 (3b). Similarly, the combination of the server S2 (3c) and the server B2 (3d) realizes a predetermined processing function. In the following explanations, servers to which request packets are delivered (i.e., destination servers) are referred to server Sn, and servers arranged behind the destination servers are referred to server Bn, where n is an arbitrary number.

The definition-management unit 1a generates and manages destination information 2a which defines servers to which request packets from clients are to be delivered, and definition-for-monitoring information 2b which defines at least one monitoring procedure and objects which are to be monitored for failure. The destination information 2a and the definition-for-monitoring information 2b are set by a user, and normally by a system administrator. For example, the load-balancing device 1 can display a screen for setting information on definitions, prompt the user to set definitions for failure monitoring, and generate the destination information 2a and the definition-for-monitoring information 2b on the basis of information inputted in accordance with the screen by the user for setting the definitions. Specifically, in the destination information 2a, a server to which a predetermined request packet received from a client is to be delivered (i.e., a destination server of the predetermined request packet) is defined according to the loads imposed on the servers which can receive the predetermined request packet. In the example illustrated in FIG. 1, the server S1 (3a) and the server S2 (3c) are defined as destination servers. In the definition-for-monitoring information 2b, servers which are to be monitored (which may be hereinafter referred to as monitored servers), at least one monitoring procedure (including a definition of a monitoring packet), and at least one criterion on the basis of which it is determined whether or not the monitored server is normal are defined. However, in the case where the criterion is obvious, e.g., in the case where the criterion is based on whether or not a response packet is returned, it is unnecessary to define the criterion. In the example illustrated in FIG. 1, in correspondence with the server S1 (3a) as a destination server, the server S1 (3a) and the server B1 (3b) are defined as servers to be monitored (monitored servers) and a monitoring procedure (including a monitoring packet), a criterion for determining normality, and the like are defined. Similarly, in correspondence with the server S2 (3c) as a destination server, the server S2 (3c) and the server B2 (3d) are defined as monitored servers, and a monitoring procedure, a criterion for determining normality, and the like are defined.

The failure-monitoring unit 1b transmits a monitoring packet to each monitored server at a predetermined time in accordance with the definition-for-monitoring information 2b produced by the definition-management unit 1a, and waits for a response from the monitored server. The monitoring packet is stipulated in a monitoring procedure defined in the definition-for-monitoring information 2b. When the monitoring packet is directly defined in the definition-for-monitoring information 2b, the directly defined monitoring packet is used. When the response packet is not received, or when a received response packet does not satisfy the corresponding criterion, the monitored server is determined to be faulty. In addition, when a monitored server corresponding to a destination server is faulty, the destination server is also determined to be faulty. The failure-monitoring unit 1b generates failure information 2c on the basis of the failure statuses of at least one monitored server and the destination server, and transfers the failure information 2c to the delivery unit 1c. In the case where a plurality of monitored servers are arranged in correspondence with a destination server, and one of the plurality of monitored servers is faulty, the failure-monitoring unit 1b determines that the destination server is also faulty, and delivery to the destination server is not allowed, because the entire processing function is not realized when even one of the plurality of monitored servers is faulty. In the failure information 2c, information on the status of each destination server indicating whether or not delivery to the destination server is allowed (i.e., whether or not the destination server is operating or faulty) is set.

The delivery unit 1c appropriately determines a destination server of a request packet from a client on the basis of the destination information 2a and the failure information 2c, and sends the request packet to the determined destination server. At this time, the request packet is not transmitted to a destination server when the failure information 2c indicates that the destination server is faulty.

The definition-management unit 1a, the failure-monitoring unit 1b, and the delivery unit 1c are realized by a computer when the computer executes a failure-monitoring program and a load-balancing program according to the present invention.

The operations of the load-balancing device 1 having the above construction are explained below.

The destination information 2a defining destination servers and the definition-for-monitoring information 2b defining at least one monitoring procedure are generated by the definition-management unit 1a and stored in the load-balancing device 1 in advance. For example, in the example of FIG. 1, it is assumed that the destination information 2a defines the server S1 (3a) and the server S2 (3c) as destination servers, and the definition-for-monitoring information 2b defines the server S1 (3a) and the server B1 (3b) as monitored servers in correspondence with the server S1 (3a) as a destination server, and the server S2 (3c) and the server B2 (3d) as monitored servers in correspondence with the server S2 (3c) as a destination server.

The failure-monitoring unit 1b sends a monitoring packet to each monitored server at a predetermined time and diagnoses the monitored server, on the basis of the definition-for-monitoring information 2b. In the case where the destination information 2a and the definition-for-monitoring information 2b define the destination servers and the monitored servers as above, the failure-monitoring unit 1b sends a monitoring packet to the server S1 (3a) and the server B1 (3b) (as the monitored servers) in order to diagnose the server S1 (3a) as a destination server. When the failure-monitoring unit 1b does not receive a response packet from the server S1 (3a) or the server B1 (3b), or when a response packet received from the server S1 (3a) or the server B1 (3b) does not satisfy the corresponding criterion, the failure-monitoring unit 1b determines the monitored server to be faulty. In addition, when either of the server S1 (3a) and the server B1 (3b) is determined to be a faulty monitored server, the failure-monitoring unit 1b determines the server S1 (3a) to be a faulty destination server. Similarly, the failure-monitoring unit 1b sends a monitoring packet to the server S2 (3c) and the server B2 (3d) (as the monitored servers) in order to diagnose the server S2 (3c) as a destination server. When the failure-monitoring unit 1b does not receive a response packet from the server S2 (3c) or the server B2 (3d), or when a response packet received from the server S2 (3c) or the server B2 (3d) does not satisfy the corresponding criterion, the failure-monitoring unit 1b determines the monitored server to be faulty. In addition, when either of the server S2 (3c) and the server B2 (3d) is determined to be a faulty monitored server, the failure-monitoring unit 1b determines the server S2 (3c) to be a faulty destination server. Information on the failure in the server S1 (3a) and the server S2 (3c) as destination servers is set in the failure information 2c, and transferred to the delivery unit 1c.

When a request packet from a client is inputted into the load-balancing device 1, the delivery unit 1c determines whether or not each of the destination servers defined in the destination information 2a is in operation, on the basis of the failure information 2c. Then, the delivery unit 1c determines one of the destination servers to which the inputted request packet is to be delivered, on the basis of the loads imposed on the destination servers which are in operation, and sends the request packet to the determined one of the destination servers. For example, in the case where the destination servers and the monitored servers are defined in the destination information 2a as mentioned before, the delivery unit 1c determines whether or not each of the server S1 (3a) and the server S2 (3c) as destination servers is in operation. When both the server S1 (3a) and the server S2 (3c) are in operation, the delivery unit 1c delivers the inputted request packet to one of the server S1 (3a) and the server S2 (3c) on which a lighter load is imposed. When only one of the server S1 (3a) and the server S2 (3c) is in operation, the delivery unit 1c delivers the inputted request packet to the one of the server S1 (3a) and the server S2 (3c).

Although, in the above explanations, the monitoring packets are directly transmitted to the server B1 (3b) and the server B2 (3d), which are located behind the server S1 (3a) and the server S2 (3c), alternatively, it is possible to define the monitoring packets for diagnosis of the server B1 (3b) and the server B2 (3d) in such a manner that the monitoring packets are transmitted through the server S1 (3a) and the server S2 (3c) to the server B1 (3b) and the server B2 (3d), respectively. Further, request packets received from clients can be used as monitoring packets. The definition-for-monitoring information 2b indicates what method is used for failure monitoring.

As explained above, according to the present invention, the definition-for-monitoring information 2b is appropriately defined. Therefore, it is possible to diagnose failure in servers located behind destination servers, as well as the destination servers, and use the results of the diagnoses when the destination servers are determined. Thus, it is possible to prevent delivery of request packets to a destination server behind which a faulty server is located.

Hereinbelow, the embodiment of the present invention is explained in detail by taking as an example a case where the present invention is applied to a load-balancing device in a client-server system in which communications are performed in accordance with the HTTPS protocol (in which the SSL encrypted communication is used in HTTP transmission).

Client-Server System

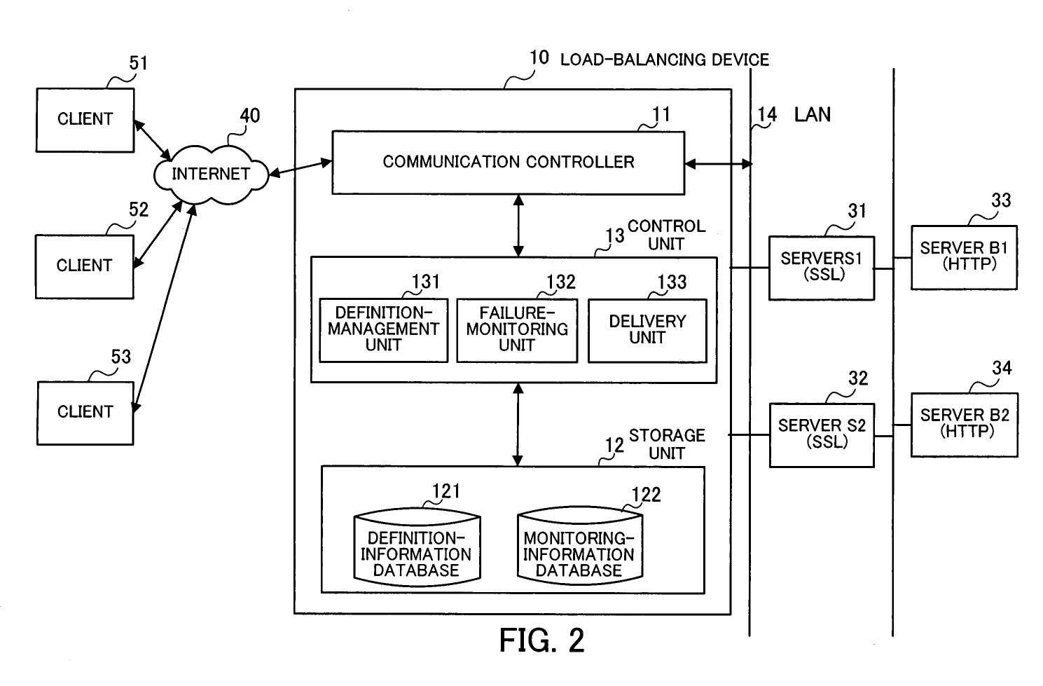

FIG. 2 is a block diagram illustrating a construction of the client-server system in which a load-balancing device according to the embodiment of the present invention is arranged.

In the client-server system of FIG. 2, a load-balancing device 10 is connected through a LAN (Local Area Network) 14 to a server S1 (31), a server S2 (32), a server B1 (33), and a server B2 (34), and through the Internet 40 to clients 51, 52, and 53. Each of the server S1 (31) and the server S2 (32) has the function of an SSL accelerator, and each of the server B1 (33) and the server B2 (34) has the function of an HTTP server. Each of the combination of the server S1 (31) and the server B1 (33) and the combination of the server S2 (32) and the server B2 (34) performs HTTPS processing.

When each of the clients 51, 52, and 53 performs HTTPS processing, the client transmits through the Internet 40 a request packet in accordance with the HTTPS protocol.

The load-balancing device 10 comprises a communication controller 11, a storage unit 12, and a control unit 13, and performs processing for monitoring servers for failure and distributing requests from the clients among the servers.

The communication controller 11 controls communications with the clients 51, 52, and 53 through the Internet 40. In addition, the communication controller 11 controls communications with the server S1 (31), the server S2 (32), the server B1 (33), and the server B2 (34) through the LAN 14. Alternatively, it is possible to arrange a plurality of communication controllers for a plurality of types of communication paths. For example, a communication controller may be arranged for each of the Internet 40 and the LAN 14.

The storage unit 12 stores data and the like which are necessary for various types of processing performed by the control unit 13. Specifically, the storage unit 12 realizes the functions of a definition-information database 121 and a monitoring-information database 122. The definition-information database 121 stores definition information such as the destination information and the definition-for-monitoring information, and the monitoring-information database 122 stores the failure information 2c such as results of diagnoses.

The control unit 13 comprises a definition-management unit 131, a failure-monitoring unit 132, and a delivery unit 133.

The definition-management unit 131 generates the destination information and the definition-for-monitoring information on the basis of definitions of destination servers and definitions related to failure monitoring, and stores the destination information and the definition-for-monitoring information in the definition-information database 121. The definitions of destination servers are set by users (including a system administrator) using terminals connected through the LAN 14, or an input device (e.g., a keyboard) and a display device (e.g., a monitor) which are connected to the load-balancing device 10.

The failure-monitoring unit 132 reads out the definition-for-monitoring information stored in the definition-information database 121, and monitors for failure the server S1 (31), the server S2 (32), the server B1 (33), and the server B2 (34) on the basis of the definition-for-monitoring information. That is, the failure-monitoring unit 132 monitors for failure not only the destination servers but also the servers which are located behind the destination servers. When the failure-monitoring unit 132 detects failure in one of the destination servers and the servers located behind the destination servers, the failure-monitoring unit 132 determines that the subsystem containing the server in which the failure is detected is faulty. Hereinafter, a server group of a destination server and at least one associated server which cooperates with the destination server to realize a predetermined processing function is referred to as a subsystem. Then, the failure-monitoring unit 132 generates failure information on the basis of the result of the monitoring, and stores the failure information in the monitoring-information database 122. Details of the processing for monitoring for failure are explained later.

When request packets in accordance with the HTTP protocol are inputted into the load-balancing device 10 from the clients 51, 52, and 53, the delivery unit 133 delivers the request packets according to the statuses of the servers. Specifically, the delivery unit 133 reads out the destination information from the definition-information database 121, and the failure information from the monitoring-information database 122, and determines whether or not each of the destination servers defined in the destination information is in operation, on the basis of the failure information. When a destination server is not in operation, the delivery unit 133 does not deliver a request packet to the destination server. In addition, it is possible to include in the definition-for-monitoring information the time at which the monitoring operation is performed, for example, so that the delivery unit 133 diagnoses the destination servers and servers located behind the destination servers before the delivery unit 133 determines a destination server of a request packet received from a client and starts transmission and reception for delivery of the request packet.

Hardware Construction

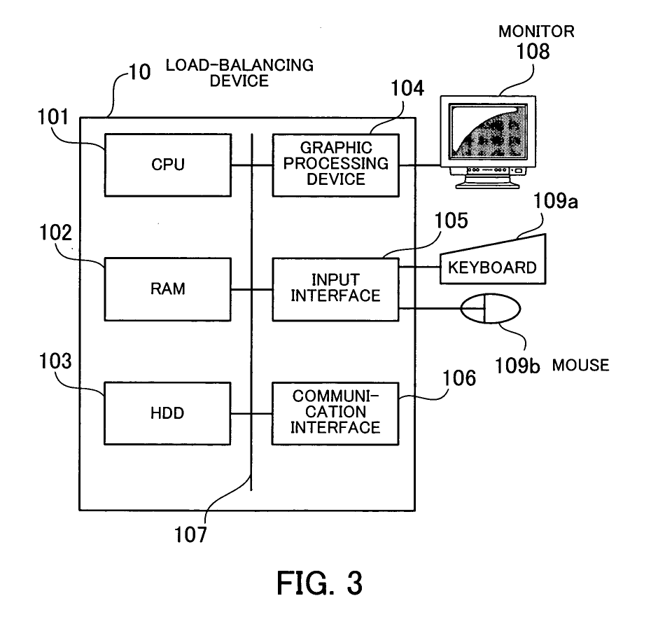

Next, the hardware construction of the load-balancing device 10 is explained with reference to FIG. 3, which is a diagram illustrating an example of the hardware construction of the load-balancing device 10. The entire load-balancing device 10 is controlled by a CPU (central processing unit) 101, to which a RAM (random access memory) 102, an HDD (hard disk drive) 103, a graphic processing device 104, an input interface 105, and a communication interface 106 are connected through a bus 107.

The RAM 102 temporarily stores at least portions of an OS (operating system) program and application programs which are executed by the CPU 101, as well as various types of data necessary for processing by the CPU 101. The HDD 103 stores the OS and the application programs.

A monitor 108 is connected to the graphic processing device 104, which makes the monitor 108 display an image on a screen in accordance with an instruction from the CPU 101. A keyboard 109a and a mouse 109b are connected to the input interface 105, which transmits signals sent from the keyboard 109a and the mouse 109b, to the CPU 101 through the bus 107.

The communication interface 106 is connected to networks. The communication interface 106 is provided for exchanging data with clients and the servers through the networks.

By using the above hardware construction, it is possible to realize processing functions in the embodiment of the present invention. Although the monitor 108, the keyboard 109a, and the mouse 109b are directly connected to the load-balancing device 10 in the construction of FIG. 3, alternatively, it is possible to indirectly connect the load-balancing device 10 with a monitor, a keyboard, and a mouse which are connected to another device with which the load-balancing device 10 can exchange data through the communication interface 106.

Failure-Monitoring Method

In the load-balancing device 10, a user defines in advance destination servers and failure-monitoring procedures for monitoring the respective destination servers. In particular, each of the failure-monitoring procedures is defined in such a manner that a monitoring packet from the load-balancing device can reach each server located behind the corresponding destination server in some way, and the load-balancing device can monitor the server located behind the corresponding destination server. Details of the failure-monitoring procedures are explained later. The definition-management unit 131 generates destination information and definition-for-monitoring information on the basis of the definition of the destination servers and the definition of the failure-monitoring procedures, respectively, where the definitions are provided by the user. The destination information and the definition-for-monitoring information are stored in the definition-information database 121 in such a manner that the destination information and the definition-for-monitoring information can be read out by the failure-monitoring unit 132 and the delivery unit 133.

The failure-monitoring unit 132 is activated at predetermined intervals. The failure-monitoring unit 132 reads out the definition-for-monitoring information from the definition-information database 121, and generates a failure-monitoring table on the basis of the definition-for-monitoring information. Then, the failure-monitoring unit 132 diagnoses failure of the respective servers on the basis of the failure-monitoring table, and generates failure information on the basis of the result of the diagnosis. The failure-monitoring unit 132 stores the failure information in the monitoring-information database 122 in such a manner that the failure information can be read out by the delivery unit 133. When the failure-monitoring unit 132 receives a request packet from a client, the delivery unit 133 is activated. The delivery unit 133 reads out the destination information from the definition-information database 121, and selects one of destination servers which are determined to be in operation, from among the destination servers defined in the destination information on the basis of the failure information.

Thus, the servers located behind the destination server can be monitored for failure. In addition, when a server located behind a destination server is faulty, request packets from clients are not delivered to the destination server.

Hereinbelow, the failure-monitoring methods executed in the embodiment of the present invention are explained in detail.

In the present embodiment, monitored servers (servers to be monitored), failure-monitoring methods, and criterions for determining normality can be defined in the definition-for-monitoring information. In the following explanations, two types of failure-monitoring methods are indicated as examples. In the first type of failure-monitoring methods, in order to confirm failure of servers located behind another server, a plurality of servers to be monitored are registered in association with a destination server, and a monitoring packet is directly transmitted to each of the plurality of servers to be monitored, for monitoring the server for failure. In the second type of failure-monitoring methods, a monitoring packet is defined for a destination server so that the monitoring packet can reach at least one other server located behind the destination server, and failure monitoring is performed by transmitting the monitoring packet.

<First Failure-Monitoring Method>

The first failure-monitoring method explained below is one of the above-mentioned first type of failure-monitoring methods, in which a plurality of servers to be monitored are defined in association with a destination server.

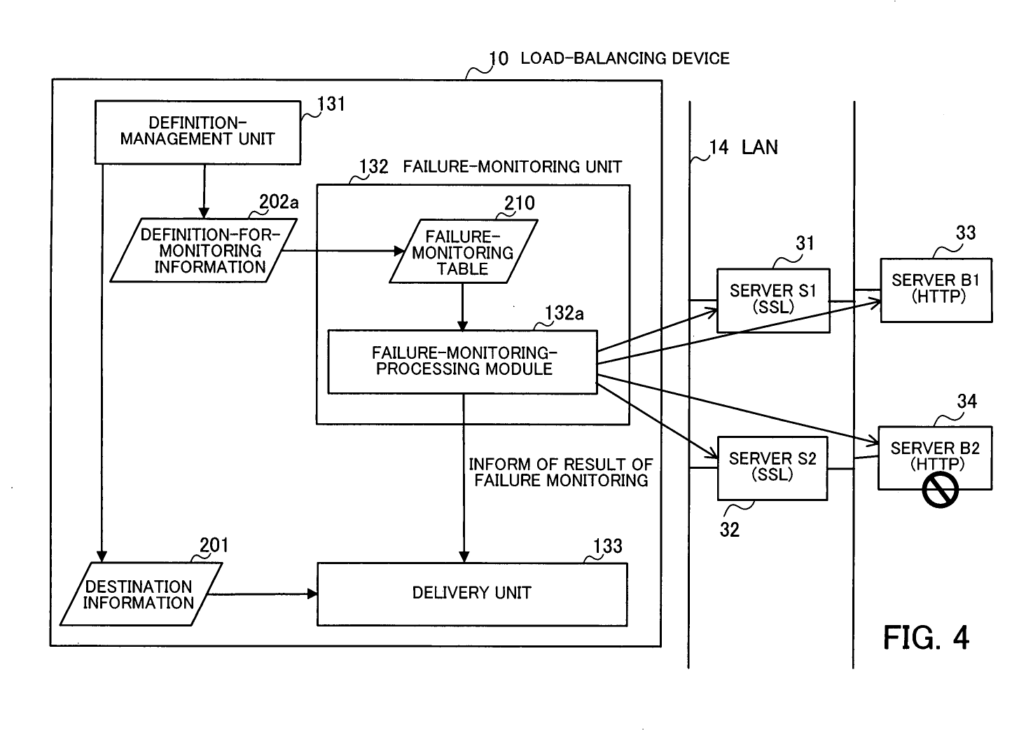

FIG. 4 is a block diagram illustrating main processing flows in the first failure-monitoring method. The first failure-monitoring method illustrated in FIG. 4 is performed in the client-server system illustrated in FIG. 2.

The definition-management unit 131 generates destination information 201 and definition-for-monitoring information 202a. In the illustrated example, the server S1 (31) and the server S2 (32) are defined as destination servers in the destination information 201. In addition, in the definition-for-monitoring information 202a, the server S1 (31) and the server B1 (33) are defined as monitored servers (servers to be monitored) corresponding to the destination server S1 (31), and the server S2 (32) and the server B2 (34) are defined as monitored servers (servers to be monitored) corresponding to the destination server S2 (32).

The failure-monitoring unit 132 produces a failure-monitoring table for use in failure-monitoring, on the basis of the definition-for-monitoring information 202a in the definition-information database 121.

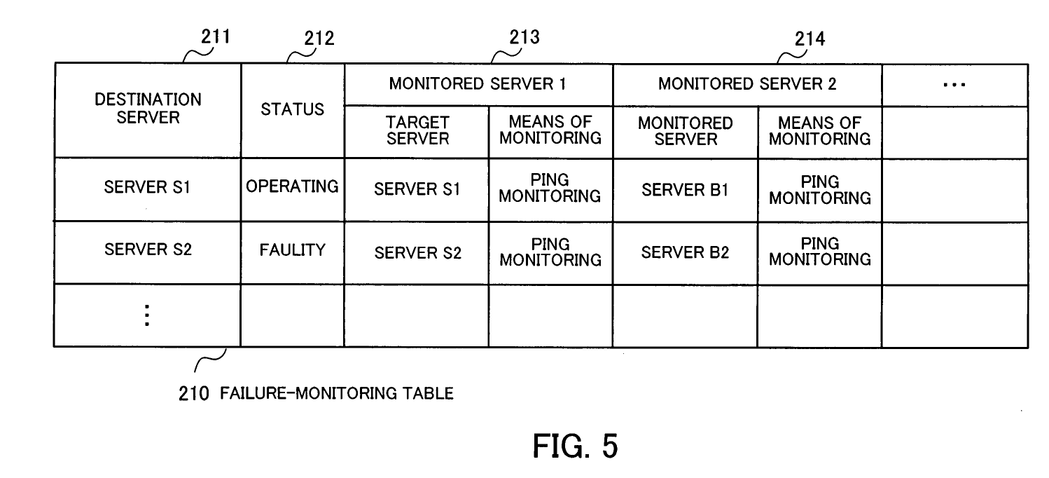

FIG. 5 is a diagram illustrating an example of the failure-monitoring table used in the first failure-monitoring method. The failure-monitoring table 210 of FIG. 5 contains the Destination Server field 211, the Status field 212, the Monitored Server 1 field 213, and the Monitored Server 2 field 214.

The Destination Server field 211 is a field for storing information on servers defined as destination servers. In the example of FIG. 5, the server S1 (31) and the server S2 (32), which are SSL accelerators, are defined as the destination servers.

The Status field 212 is a field for storing information indicating whether or not a request packet can be delivered to each destination server. Specifically, information indicating “Operating (Delivery is Allowed)” or “Faulty (Delivery is Not Allowed)” is set in this field after diagnosis is completed.

The Monitored Server 1 field 213 is a field for storing definitions of the first monitored servers corresponding to each destination server, and failure-monitoring procedures for the first monitored servers. In the example of FIG. 5, the server S1 (31) per se is defined as the first monitored server corresponding to the destination server S1 (31), and ping monitoring is defined as the failure-monitoring procedure for the monitored server S1 (31). Similarly, the server S2 (32) per se is defined as the first monitored server corresponding to the destination server S2 (32), and ping monitoring is defined as the failure-monitoring procedure for the monitored server S2 (32).

The Monitored Server 2 field 214 is a field for storing definitions of the second monitored servers corresponding to each destination server, and failure-monitoring procedures for the second monitored servers. In the example of FIG. 5, the server B1 (33), which is located behind the server S1 (31), is defined as the second monitored server corresponding to the destination server S1 (31), and ping monitoring is defined as the failure-monitoring procedure for the monitored server B1 (33). Similarly, the server B2 (34), which is located behind the server S2 (32), is defined as the second monitored server corresponding to the destination server S2 (32), and ping monitoring is defined as the failure-monitoring procedure for the monitored server B2 (34).

The contents of the fields except for the Status field 212 in the failure-monitoring table are generated on the basis of the definition-for-monitoring information. In addition, when at least one further server is located behind the second monitored server in correspondence with one of the destination servers, at least one additional field corresponding to the at least one further server and following the Monitored Server 2 field 214 is arranged in the failure-monitoring table, and information determined in a similar manner to the Monitored Server 2 field 214 is set in each of the at least one additional field in succession. On the other hand, the Status field 212 corresponds to the failure information which is set on the basis of the failure monitoring processing.

The failure-monitoring unit 132 comprises a failure-monitoring-processing module 132a which executes the first failure-monitoring method. When the failure-monitoring table is set as above, the failure-monitoring-processing module 132a performs ping monitoring processing for the server S1 (31), the server S2 (32), the server B1 (33), and the server B2 (34) which are defined in the failure-monitoring table 210, as explained below. In the following explanations of the first failure-monitoring method, it is assumed that the server B2 (34) located behind the server S2 (32) is faulty.

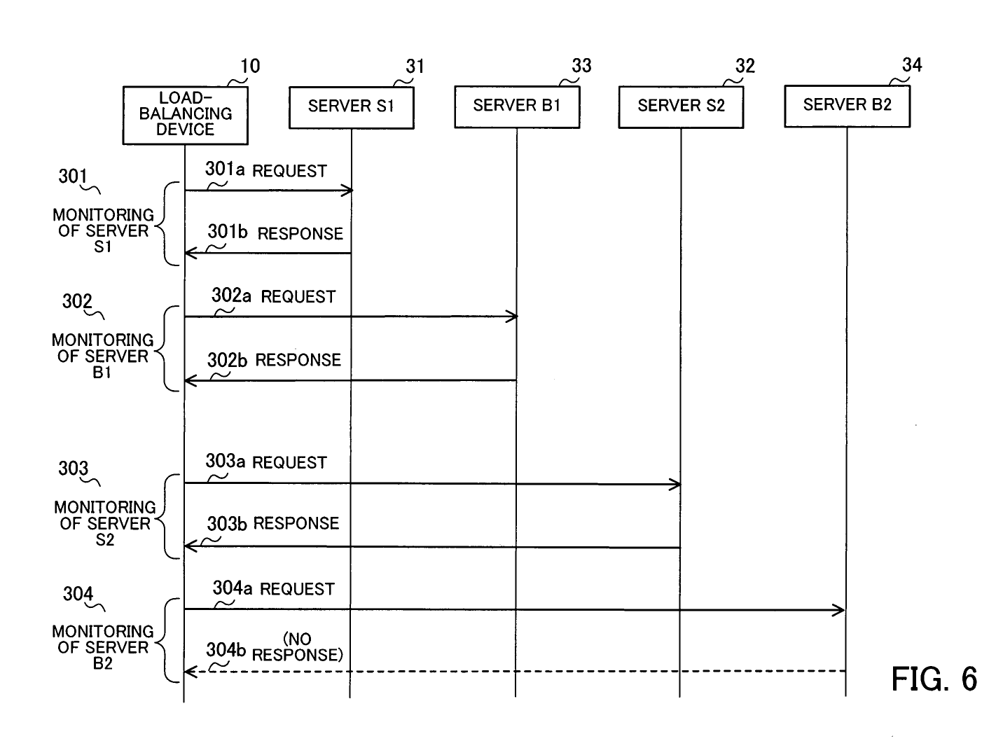

FIG. 6 is a sequence diagram illustrating a sequence of failure-monitoring processing in the first failure-monitoring method.

The ping monitoring is a monitoring technique used for determining whether or not an IP packet does or can reach a destination in a TCP/IP network, and realized by using ICMP (Internet Control Message Protocol). When ping is executed and a ping response is returned, it is determined that the counterparty node exists, and the network software (at least in the IP layer) is active.

First, monitoring of the subsystem containing the server S1 (31) is performed by using the failure-monitoring table 210. Specifically, failure-monitoring processing 301 for monitoring the server S1 for failure is performed, and subsequently failure-monitoring processing 302 for monitoring the server B1 for failure is performed. In the example of FIG. 6, in the failure-monitoring processing 301, a request command 301a is transmitted from the load-balancing device 10 to the server S1 (31), and a response command 301b is returned, so that the load-balancing device 10 determines that the server S1 (31) is normal. In addition, in the failure-monitoring processing 302, a request command 302a is transmitted from the load-balancing device 10 to the server B1 (33), and a response command 302b is returned, so that the load-balancing device 10 determines that the server B1 (33) is also normal. Since both the server S1 (31) and the server B1 (33) are normal, the load-balancing device 10 determines that the subsystem containing the server S1 (31) is in operation.

Next, monitoring of the subsystem containing the server S2 (32) is performed by using the failure-monitoring table 210. Specifically, failure-monitoring processing 303 for monitoring the server S2 for failure is performed, and subsequently failure-monitoring processing 304 for monitoring the server B2 for failure is performed. In the example of FIG. 6, in the failure-monitoring processing 303, a request command 303a is transmitted from the load-balancing device 10 to the server S2 (32), and a response command 303b is returned, so that the load-balancing device 10 determines that the server S2 (32) is normal. In addition, in the failure-monitoring processing 304, a request command 304a is transmitted from the load-balancing device 10 to the server B2 (34). However, no response (304b) is returned from the server B2 (34), so that the load-balancing device 10 determines that the server B2 (34) is faulty. Since the server B2 (34) is faulty, the load-balancing device 10 determines that the subsystem containing the server S2 (32) is faulty.

Through the above failure-monitoring processing, information indicating that the subsystem containing the server S1 (31) is in operation and the subsystem containing the server S2 (32) is faulty is set in the Status field 212 of the failure-monitoring table 210. Thus, the delivery unit 133 does not deliver packets to the server S2 (32).

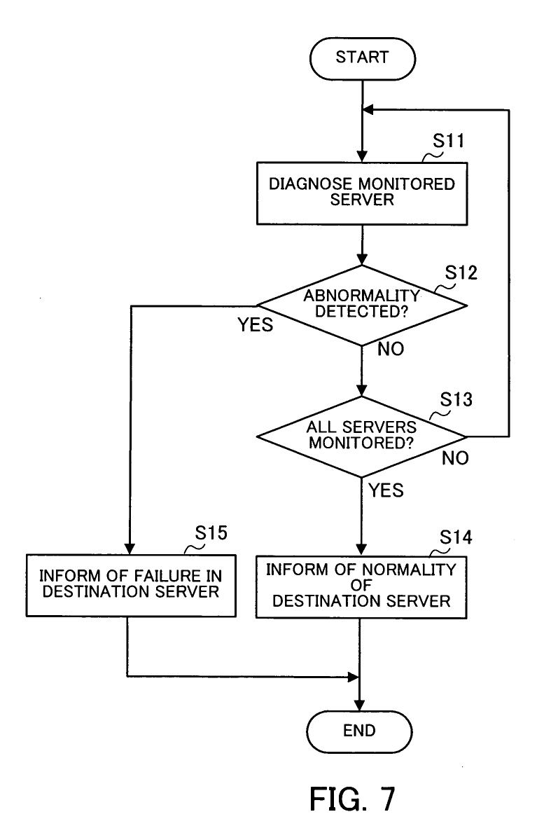

Details of the sequence of the failure-monitoring processing according to the first failure-monitoring method are explained below with reference to FIG. 7, which is a flow diagram illustrating the failure-monitoring processing according to the first failure-monitoring method. The sequence of the failure-monitoring processing of FIG. 7 is started when the failure-monitoring-processing module 132a is activated.

<Step S11> The failure-monitoring-processing module 132a diagnoses one of one or more monitored servers which are defined in correspondence with a destination server, on the basis of the failure-monitoring table in accordance with a defined failure-monitoring procedure.

<Step S12> The failure-monitoring-processing module 132a determines whether or not an abnormality is detected in the monitored server by the diagnosis. When yes is determined, the operation goes to step S15. When no is determined, the operation goes to step S13.

<Step S13> The failure-monitoring-processing module 132a determines whether or not the diagnosis of all of the one or more monitored servers defined in correspondence with the destination server is completed. When yes is determined, the operation goes to step S14. When no is determined, the operation goes back to step S11 in order to perform the operations in steps S11 to S13 on the next one of the one or more monitored servers defined in correspondence with the destination server.

<Step S14> Since all of the one or more monitored servers defined in correspondence with the destination server are determined to be normal, the failure-monitoring-processing module 132a sets in the failure-monitoring table the information indicating the destination server is in operation (i.e., request packets can be delivered to the destination server), and informs the delivery unit 133 of the result of the diagnosis.

<Step S15> Since the subsystem containing the destination server includes a faulty monitored server, the failure-monitoring-processing module 132a determines that the subsystem containing the destination server cannot perform the requested processing, sets in the failure-monitoring table the information indicating the destination server is faulty (i.e., the request packets cannot be delivered to the destination server), and informs the delivery unit 133 of the result of the diagnosis.

As described above, according to the first failure-monitoring method, the servers located behind the destination server can be defined as servers to be monitored, and monitoring packets are transmitted to all of the servers to be monitored, so as to monitor for failure the servers to be monitored. When failure in at least one of the servers to be monitored is detected, the subsystem containing the faulty server is determined to be faulty. Thus, it is possible to monitor all servers, and prevent delivery of requests from clients to the subsystem which cannot perform processing.

<Second Failure-Monitoring Method>

The second failure-monitoring method explained below is one of the aforementioned second type of failure-monitoring methods, in which a monitoring packet which can reach through a destination server a server located behind the destination server is defined and used.

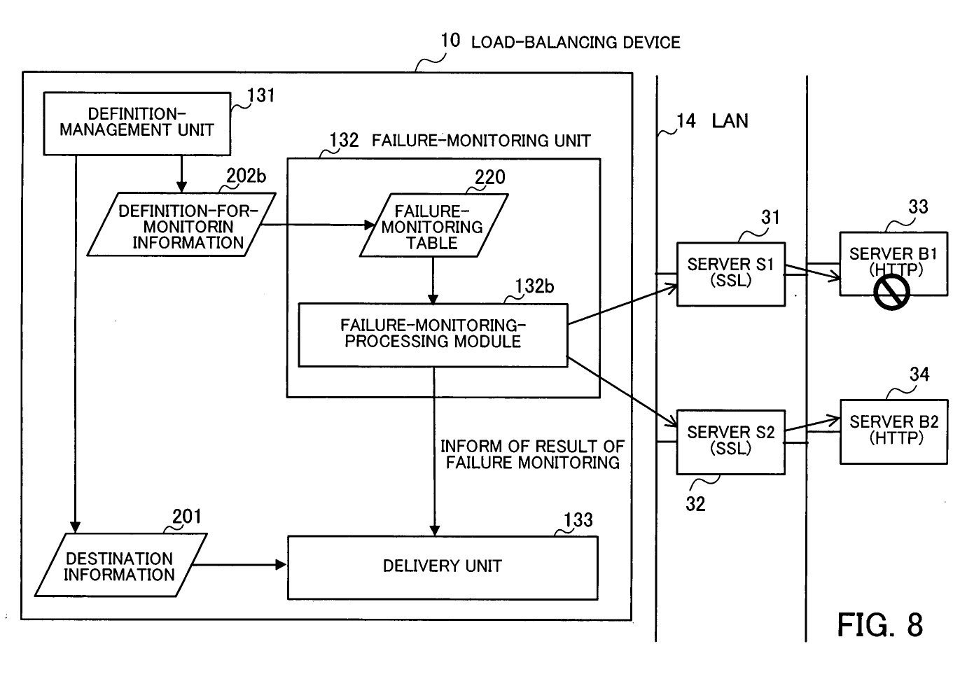

FIG. 8 is a block diagram illustrating main processing flows in the second failure-monitoring method. The second failure-monitoring method illustrated in FIG. 8 is also performed in the client-server system illustrated in FIG. 2.

The definition-management unit 131 generates destination information 201 and definition-for-monitoring information 202b. In the illustrated example, the server S1 (31) and the server S2 (32) are defined as destination servers in the destination information 201. In addition, in the definition-for-monitoring information 202b, a failure-monitoring procedure using a monitoring packet which can reach the server B1 (33) through the server S1 (31) is defined in correspondence with the server S1 (31), and another failure-monitoring procedure using a monitoring packet which can reach the server B2 (34) through the server S2 (32) is defined in correspondence with the server S2 (32).

The failure-monitoring unit 132 produces a failure-monitoring table for use in failure-monitoring processing, on the basis of the definition-for-monitoring information 202b in the definition-information database 121.

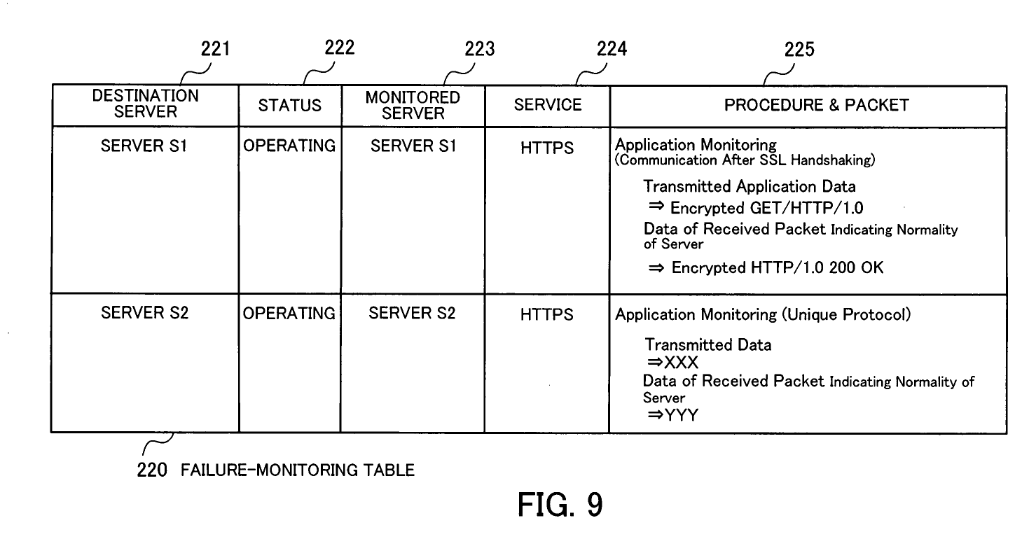

FIG. 9 is a diagram illustrating an example of the failure-monitoring table used in the second failure-monitoring method. The failure-monitoring table 220 of FIG. 9 contains the Destination Server field 221, the Status field 222, the Monitored Server field 223, the Service field 224, and the Procedure & Packet field 225.

The Destination Server field 221 is a field for storing information on servers defined as destination servers. In the example of FIG. 9, the server S1 (31) and the server S2 (32), which are SSL accelerators, are defined as the destination servers.

The Status field 222 is a field for storing information indicating whether or not a request packet can be delivered to each destination server. Specifically, information indicating “Operating (Delivery is Allowed)” or “Faulty (Delivery is Not Allowed)” is set in this field after diagnosis is completed.

The Monitored Server field 223 is a field for storing definitions of destination servers to which monitoring packets are to be transmitted from the load-balancing device 10. In the example of FIG. 9, the destination server S1 (31) per se is also defined as a monitored server. Similarly, the destination server S2 (32) per se is also defined as a monitored server.

The Service field 224 is a field for storing definitions of services used in the failure monitoring. In the example of FIG. 9, the definition in correspondence with the server S1 (31) indicates that the procedure in accordance with the HTTPS service is utilized for failure monitoring, and a similar definition is stored in correspondence with the server S2 (32).

The Procedure & Packet field 225 is a field for storing the definition of a monitoring procedure in correspondence with each destination server. The definition of the monitoring procedure includes the type of the monitoring procedure, the monitoring packet to be transmitted, and a condition for determining normality of a subsystem containing the destination server and at least one associated server which cooperates with the destination server for performing processing.

In the example of the failure-monitoring table 220 illustrated in FIG. 9, a procedure for diagnosis using HTTPS is defined for the subsystem containing the server S1 (31) as a destination server, and a procedure for diagnosis using a unique protocol is defined for the subsystem containing the server S2 (32) as a destination server.

Specifically, the definitions for the subsystem containing the server S1 (31) indicated in the Procedure & Packet field 225 are as follows:

The monitoring procedure is indicated as “Application Monitoring (Communication after SSL handshaking is monitored),” the transmission data is indicated as “Application Data (encrypted GET/HTTP/1.0),” and the data of a received packet which leads to a determination that the server of interest is in operation is indicated as “Encrypted HTTP/1.0 200 OK.”

In the HTTPS service, an SSL handshaking procedure is performed between the load-balancing device 10 and a destination server, and application processing is performed when the SSL handshaking procedure is normally completed. Although monitoring of processing before completion of an SSL handshaking has been conventionally performed, the monitoring according to the present embodiment can use a packet transmitted in a procedure after the SSL handshaking. This is because in the processing before the SSL handshaking, packets cannot reach a server located behind a destination server, and the server located behind a destination server cannot be diagnosed. Therefore, in the illustrated example, application data which can reach the HTTP server (i.e., the server B1 (33)) located behind the destination server S1 (31) is defined as transmission data. When the load-balancing device 10 receives an OK packet in response to the transmission data, it is determined that the subsystem containing the destination server S1 (31) is in operation.

In addition, the definitions for the subsystem containing the server S2 (32) indicated in the Procedure & Packet field 225 are as follows:

The monitoring procedure is indicated as “Application Monitoring (Unique Protocol),” the transmission data is indicated as “XXX (Unique Data),” and the data of a received packet which leads to a determination that the server of interest is in operation is indicated as “YYY (Normal response from a server in operation).” In order to execute this monitoring procedure, it is necessary to set the destination server in advance so that when the destination server receives data in accordance with the unique protocol, the destination server transfers the data in accordance with the unique protocol to the associated server which cooperates with the destination server, and transfers to the load-balancing device 10 a response obtained from the associated server.

As illustrated in FIG. 8, the failure-monitoring unit 132 comprises a failure-monitoring-processing module 132b which executes the second failure-monitoring method. On the basis of the above definitions in the failure-monitoring table 220, the failure-monitoring-processing module 132b transmits a packet which can be transferred through a monitored server (the server S1 (31)) defined in the failure-monitoring table 220, to the server (the server B1 (33)) located behind the server S1 (31), and monitors the subsystem containing the server S1 (31) and the server B1 (33) for failure. Similarly, the failure-monitoring-processing module 132b transmits a packet which can be transferred through another monitored server (the server S2 (32)) defined in the failure-monitoring table 220, to the server (the server B2 (34)) located behind the server S2 (32), and monitors the subsystem containing the server S2 (32) and the server B2 (34) for failure.

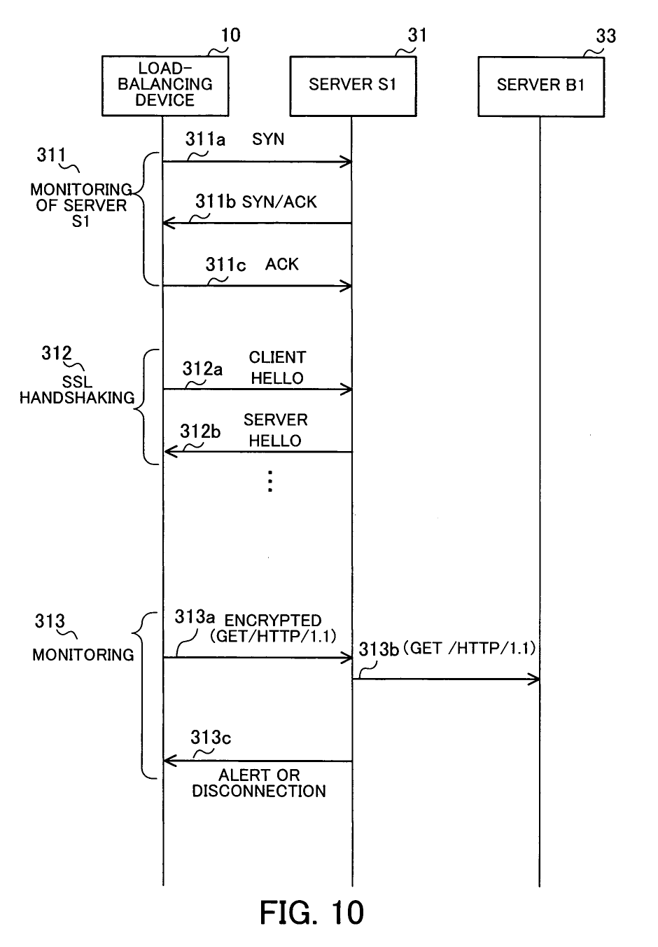

FIG. 10 is a sequence diagram illustrating a sequence of failure-monitoring processing in the second failure-monitoring method. In the example of FIG. 10, the failure-monitoring processing uses HTTPS.

First, in order to diagnose the subsystem containing the server S1 (31), failure-monitoring processing 311 for monitoring the server S1 for failure is performed on the basis of the failure-monitoring table 220. When the server S1 (31) is determined to be normal, SSL handshaking 312 is performed, and then failure-monitoring processing 313 for monitoring the subsystem including the server B1 (33) for failure is performed.

Specifically, in the processing sequence of the HTTPS protocol, a SYN packet 311a is transmitted from the load-balancing device 10 to the server S1 (31) in order to establish a connection between the load-balancing device 10 and the server S1 (31). When the server S1 (31) can perform communication, the server S1 (31) returns a SYN/ACK packet 311b to the load-balancing device 10. Then, the load-balancing device 10 transmits an ACK packet 311c. Thus, a connection is established, and thereafter SSL handshaking 312 is performed. In the SSL handshaking 312, the load-balancing device 10 transmits a Client Hello packet 312a, and the server S1 (31) returns a Server Hello packet 312b. Through the above sequence, the negotiation between the load-balancing device 10 and the server S1 (31) is completed, and application processing is started. When an abnormality is detected during the above processing, the subsystem containing the destination server S1 (31) is determined to be faulty.

The failure-monitoring processing 313 is performed as follows.

An encrypted GET/HTTP/1.1 packet 313a as the application data is transmitted to the server S1 (31). The server S1 (31) as an SSL accelerator decrypts the encrypted GET/HTTP/1.1 packet 313a, and sends a GET/HTTP/1.1 packet 313b to the server B1 (33). When the server B1 (33) is normal, the server B1 (33) acquires the GET/HTTP/1.1 packet 313b, and returns response data corresponding to the GET/HTTP/1.1 packet 313b. On the other hand, when the server B1 (33) is faulty, no response is returned to the server S1 (31), or an error response is returned to the server S1 (31). In this case, the server S1 (31) informs the load-balancing device 10 of the failure in reception of a normal response, by transmitting an alert or disconnect packet 313c to the load-balancing device 10. When the load-balancing device 10 receives a normal response, the load-balancing device 10 determines that the subsystem containing the server S1 (31) is in operation. On the other hand, when the load-balancing device 10 receives the alert or disconnect packet 313c, the load-balancing device 1 determines the subsystem containing the server S1 (31) to be faulty.

On the basis of the above sequence, information indicating whether or not request packets can be delivered to each destination server is set in the Status field 222 in the failure-monitoring table 220.

In the case where the unique protocol is designated, the failure monitoring processing 313 is directly performed.

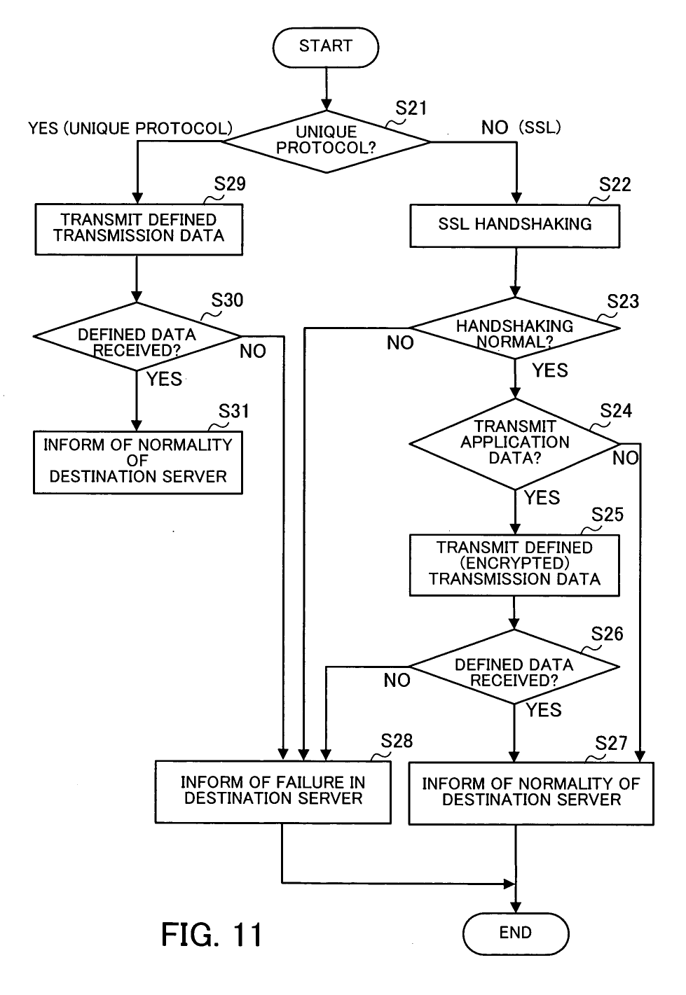

Details of the sequence of the failure-monitoring processing according to the second failure-monitoring method are explained below with reference to FIG. 11, which is a flow diagram illustrating the failure-monitoring processing according to the second failure-monitoring method. The sequence of the failure-monitoring processing of FIG. 11 is started when the failure-monitoring-processing module 132b is activated.

<Step S21> The failure-monitoring-processing module 132b reads in the failure-monitoring table 220, and determines whether or not the failure-monitoring procedure uses a unique protocol or an application protocol which is originally used by the subsystem containing the destination server. When the unique protocol is used, the operation goes to step S29. When the application protocol is used, the operation goes to step S22.

<Step S22> Since, in this case, the application protocol which is originally used by the subsystem containing the destination server, processing in accordance with the application protocol is performed. Since, in this case, the application protocol is the HTTPS protocol, SSL handshaking is performed.

<Step S23> It is determined whether or not the SSL handshaking is normally completed. When no is determined, the operation goes to step S28. When yes is determined, the operation goes to step S24.

<Step S24> It is determined whether or not application data is defined and transmission of the application data is defined. When no is determined, the operation goes to step S27, and processing for diagnosis is discontinued. When yes is determined, the operation goes to step S25.

<Step S25> The transmission data defined in the failure-monitoring table 220 is transmitted. Since, in this case, the destination server is an SSL accelerator, encrypted transmission data which can reach the HTTP server located behind the destination server is transmitted.

<Step S26> When the failure-monitoring-processing module 132b acquires a response packet from the destination server, the failure-monitoring-processing module 132b compares the response packet with an expected response packet which is defined in the failure-monitoring table 220 as a packet expected to be received in the normal case. When no response packet is received, or when the received response packet is different from the expected response packet, the operation goes to step S28. When the received response packet matches the expected response packet, the operation goes to step S27.

<Step S27> The operation in this step is performed when no transmission data is transmitted for monitoring (and therefore no monitoring is performed), or when it is determined in step S26 that the normal (defined) response is received. The failure-monitoring-processing module 132b sets in the failure-monitoring table 220 information indicating that the destination server is in operation (i.e., request packets can be delivered to the destination server), informs the delivery unit 133 that the destination server is in operation, and completes the processing of FIG. 11.

<Step S28> The operation in this step is performed when the SSL handshaking is not normally completed, or when a normal response to the application data transmitted for monitoring is not received. The failure-monitoring-processing module 132b sets in the failure-monitoring table 220 information indicating that the destination server is faulty (i.e., request packets cannot be delivered to the destination server), informs the delivery unit 133 that the destination server is faulty, and completes the processing of FIG. 11.

<Step S29> Since failure monitoring using the unique protocol is defined, the failure-monitoring-processing module 132b transmits the transmission data defined in the failure-monitoring table 220.

<Step S30> When a response packet is received from the destination server, the failure-monitoring-processing module 132b compares the received response packet with an expected response packet which is defined in the failure-monitoring table 220 as a packet expected to be received in the normal case. When no response packet is received, or when the received response packet is different from the expected response packet, the operation goes to step S28. When the received response packet matches the expected response packet, the operation goes to step S31.

<Step S31> Since it is determined in step S30 that the normal (defined) response is received, the failure-monitoring-processing module 132b sets in the failure-monitoring table 220 information indicating that the destination server is in operation (i.e., request packets can be delivered to the destination server), informs the delivery unit 133 that the destination server is in operation, and completes the processing of FIG. 11.

As described above, according to the second failure-monitoring method, failure monitoring is performed by transmitting a monitoring packet which can reach a monitored server (i.e., a server to be monitored) located behind a destination server. When an expected response is not received, the subsystem containing the destination server is determined to be faulty. Therefore, it is possible to monitor in an application layer each subsystem constituted by a destination server and an associated server which cooperates with the destination server, and prevent delivery of request packets to a subsystem which cannot perform processing. The second failure-monitoring method does not care about which server in each subsystem is faulty.

<Third Failure-Monitoring Method>

In the first and second failure-monitoring methods, the failure-monitoring unit 132 in the load-balancing device 10 monitors for failure by periodically transmitting monitoring packets. Therefore, failure can be detected only at regular intervals. If failure occurs between the timings of the monitoring operations, the load-balancing device 10 cannot recognize the occurrence of the failure immediately after the occurrence, and prevent delivery of request packets received from clients to the faulty subsystem.

In order to overcome the above problem, a third failure-monitoring method is indicated below. According to the third failure-monitoring method, failure in a destination server can be determined through exchange of packets between a client and the destination server. However, according to the third failure-monitoring method, at least one packet from the client is delivered to the destination server. Therefore, it is desirable to use the third failure-monitoring method together with the first or second failure-monitoring method.

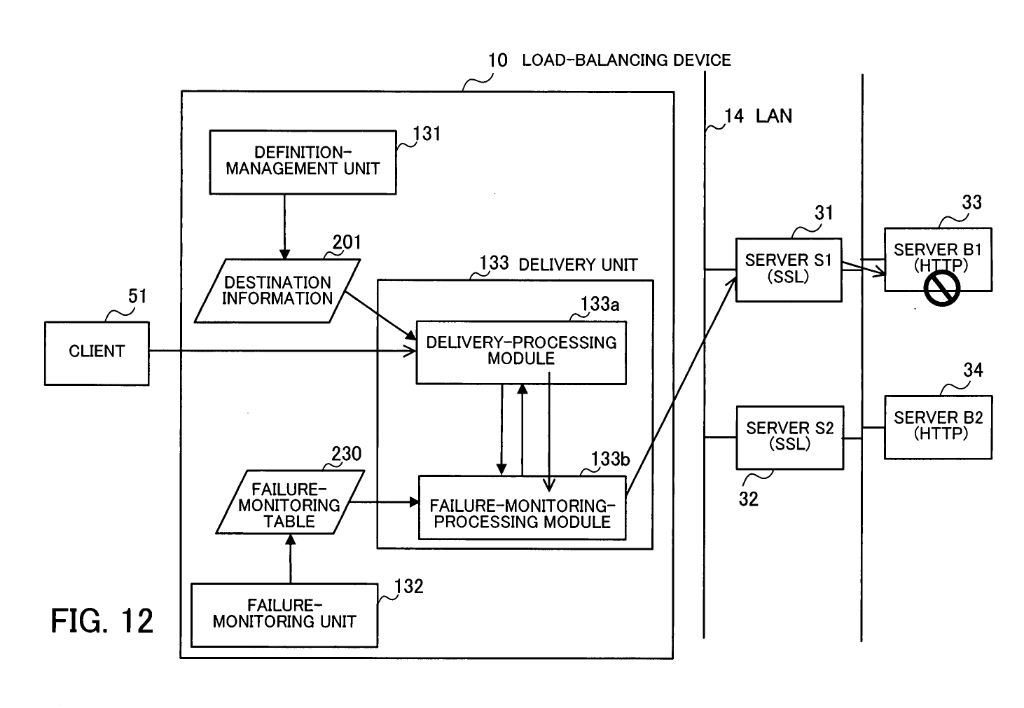

FIG. 12 is a block diagram illustrating main processing flows in the third failure-monitoring method. In FIG. 12, the third failure-monitoring method is also performed in the client-server system illustrated in FIG. 2.

The definition-management unit 131 generates destination information 201 and definition-for-monitoring information (not shown), and the failure-monitoring unit 132 generates a failure-monitoring table 230 on the basis of the destination information 201 and the definition-for-monitoring information. In the illustrated example, the server S1 (31) and the server S2 (32) are defined as destination servers in the destination information 201. In addition, a failure-monitoring procedure for monitoring packets which are normally delivered to the destination server S1 (31) is defined in the definition-for-monitoring information. Specifically, a monitored packet (i.e., a packet to be monitored) is defined from among packets delivered to the destination server S1 (31), and a condition for determining whether or not the destination server is in operation is defined. Similarly, a failure-monitoring procedure for monitoring packets which are normally delivered to the destination server S2 (32) is defined.

The delivery unit 133 comprises a delivery-processing module 133a and a failure-monitoring-processing module 133b. In the delivery unit 133, when the delivery-processing module 133a receives a request packet from the client 51, the delivery-processing module 133a passes the request packet to the failure-monitoring-processing module 133b. Then, the failure-monitoring-processing module 133b determines whether or not the received request packet corresponds to a packet to be monitored (monitored packet) which is defined in the failure-monitoring table 230. When the received request packet does not match the packet to be monitored, the monitoring processing is discontinued, and the subsequent processing is performed by the delivery-processing module 133a. When the received request packet corresponds to the packet to be monitored, the delivery-processing module 133a performs failure-monitoring processing by using the packet to be monitored.

Since data in the SSL packets in accordance with the HTTPS protocol are encrypted, the contents of SSL packets transmitted between the clients and the servers cannot be seen. For example, it is impossible to define failure monitoring based on determination as to whether or not an HTTP/1.1 200 OK packet is received from a server as a response to a GET/HTTP/1.0 packet sent from a client as a request. Therefore, according to the third failure-monitoring method, a portion, indicating a communication status, of a response packet is referred to in order to determine whether or not the subsystem is in operation or faulty.

Hereinbelow, some examples of reference data contained in an SSL packet returned from the destination server S1 (31) or S2 (32) are explained. The failure-monitoring-processing module 133b determines whether or not the subsystem containing the server S1 (31) or S2 (32) is in operation or faulty on the basis of the reference data.

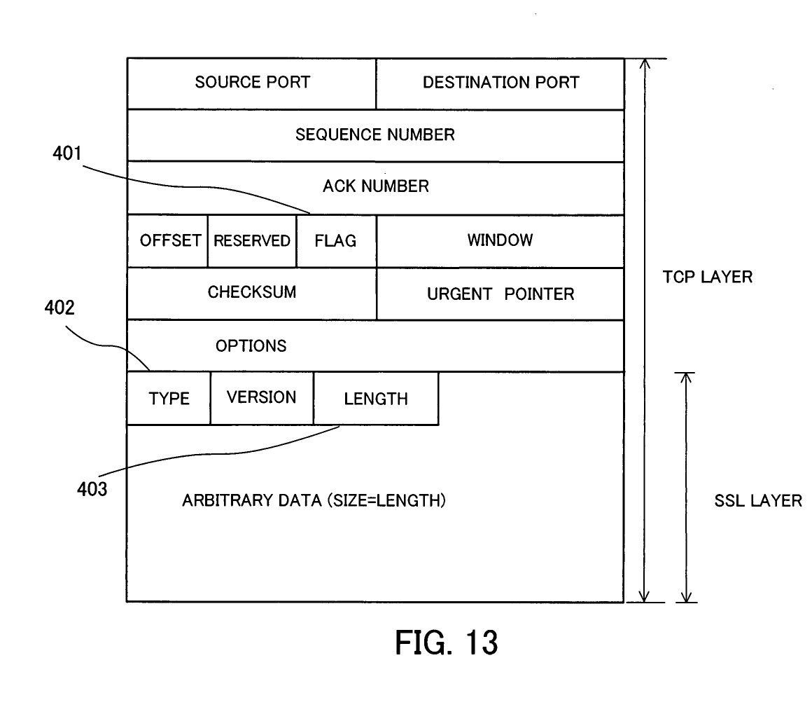

FIG. 13 is a diagram illustrating the structures of portions, corresponding to the TCP layer and the SSL layer, of a packet in accordance with the HTTPS protocol.

The failure-monitoring-processing module 133b determines whether or not the subsystem containing the server S1 (31) or S2 (32) is in operation or faulty, by referring to the contents of the fields of Flag (401), Type (402), and Length (403) illustrated in FIG. 13.

The information in the field of Flag (401) is set in the TCP layer. In a connection between a client and a server (SSL accelerator), normally, the server returns an encrypted response to an encrypted request packet which is transmitted from the client immediately after SSL handshaking. At this time, when another server located behind the above server as the SSL accelerator is faulty, the SSL accelerator does not return a response, and simply disconnects the connection. Therefore, when the FIN bit or the RST bit is set in the field of Flag (401), the failure-monitoring-processing module 133b determines that the connection is disconnected, and the subsystem is faulty.

The information in the field of Type (402) indicates the type of the SSL packet (e.g., handshaking, application data, or alert), and is set in the SSL layer. As in the case of disconnection, when a server located behind an SSL accelerator is faulty, the SSL accelerator returns an Alert packet (as one of the SSL packets) instead of a response. Thereafter, the connection may be disconnected. In the field of Type (402), “0x17 (=23)” is set when the SSL packet contains application data, or “0x15 (=21)” is set when the SSL packet is an Alert packet. Therefore, when the failure-monitoring-processing module 133b detects that the SSL packet is an Alert packet, the failure-monitoring-processing module 133b determines the destination server to be faulty.

The information in the field of Length (403) indicates the length of the data following the field of Type (402), and is set in the SSL layer. The encrypted request packets from clients are characterized by having great length. In addition, the responses to the encrypted request packets returned from a destination server are characterized by having great length when another server exists behind the destination server, and small length when no server exists behind the destination server. Therefore, the failure-monitoring-processing module 133b determines whether or not the subsystem is faulty, on the basis of the length of the response to each encrypted request packet.

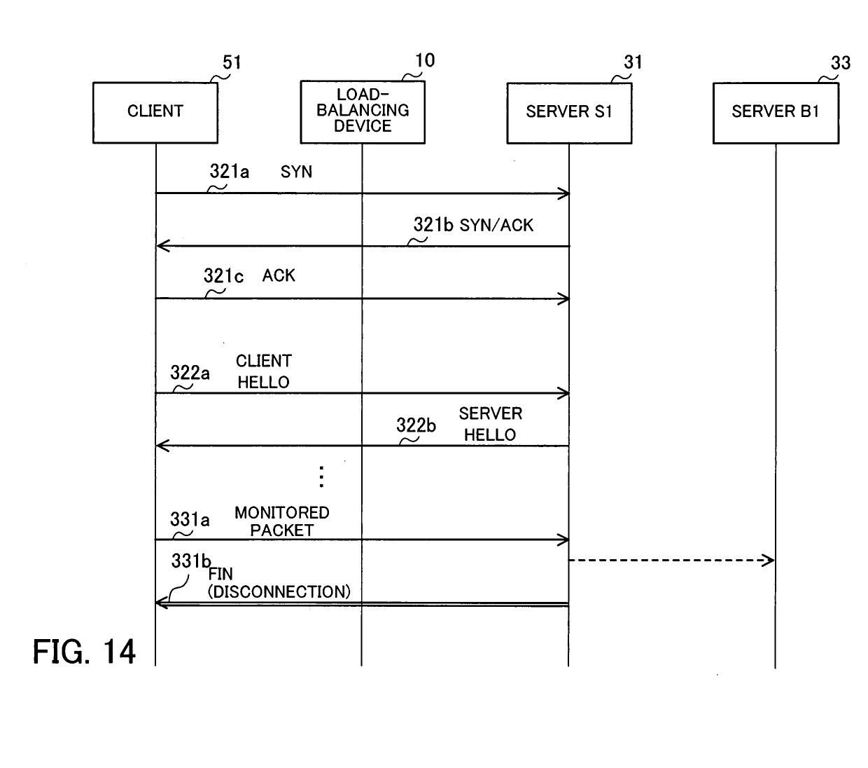

FIG. 14 is a sequence diagram illustrating a sequence of failure-monitoring processing according to the third failure-monitoring method. FIG. 14 shows a sequence of operations performed when the server B1 (33) located behind the destination server S1 (31) is faulty.

First, a sequence of operations for establishing a connection between the client 51 and the server S1 (31) through the load-balancing device 10 is started. Specifically, the load-balancing device 10 selects the destination server S1 (31) as a destination, and transfers to the server S1 (31) a packet received from the client 51. In this case, the client 51 transmits a SYN packet (321a) in order to establish a connection with the server S1 (31). When the server S1 (31) can perform communication, a SYN/ACK packet (321b) is returned to the client 51. Then, the client 51 transmits an ACK packet (321c). Thus, a connection is established, and thereafter SSL handshaking is performed. In the SSL handshaking, the client 51 transmits a Client Hello packet (322a), and the server S1 (31) returns a Server Hello packet (322b). Through this sequence, a negotiation between the client 51 and the server S1 (31) is completed, and then application processing is started. When an abnormality is detected during the above processing, the subsystem containing the destination server is determined to be faulty.

After the application processing is started, when a packet to be monitored (monitored packet) 331a is transmitted from the client 51, the failure-monitoring-processing module 133b in the delivery unit 133 detects the monitored packet 331a, and starts failure-monitoring processing. Specifically, the monitored packet 331a is transferred through the server S1 (31) to the server B1 (33). However, since the server B1 (33) is assumed to be faulty in the example illustrated in FIG. 14, the server B1 (33) cannot return a response to the monitored packet 331a. Therefore, the server S1 (31) returns a FIN packet 331b for disconnection. The failure-monitoring-processing module 133b detects the FIN packet 331b, and determines the subsystem containing the server S1 (31) to be faulty.

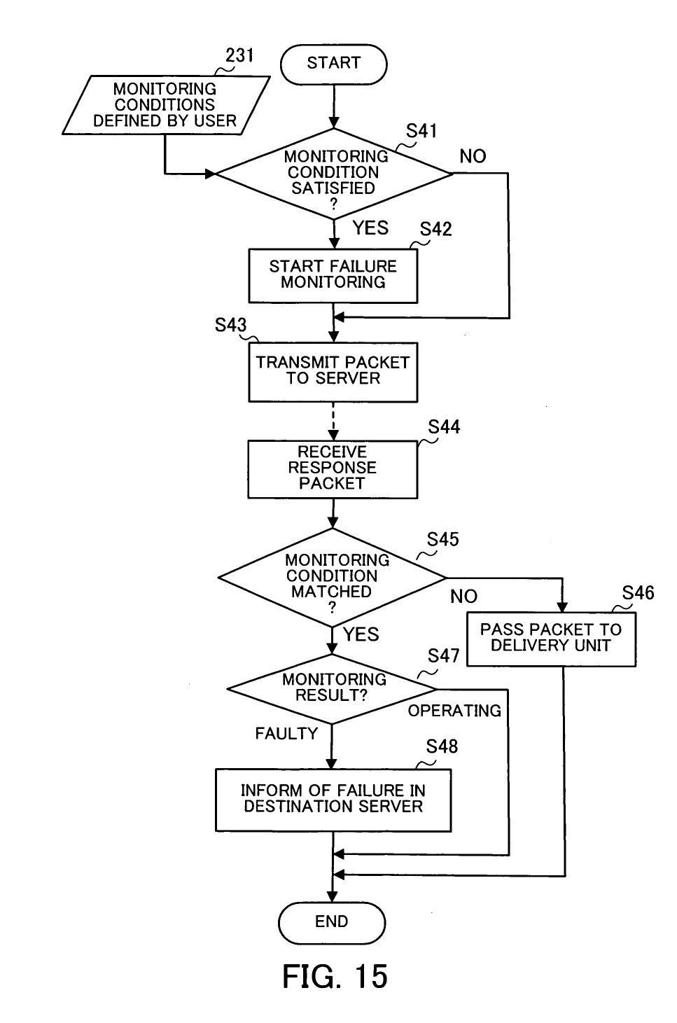

Details of the sequence of the failure-monitoring processing according to the third failure-monitoring method are explained below with reference to FIG. 15, which is a flow diagram illustrating the failure-monitoring processing according to the third failure-monitoring method. The sequence of the failure-monitoring processing of FIG. 15 is started when the load-balancing device 10 receives a request packet from the client 51 and the delivery unit 133 is activated.

<Step S41> The delivery unit 133 reads in the monitoring conditions defined by the user, from the failure-monitoring table 230, compares the packet received from the client, with the monitoring conditions so as to determine whether or not the received packet satisfies the monitoring conditions. When no is determined, the operation goes to step S43. When yes is determined, the operation goes to step S42.

<Step S42> Since the received packet satisfies the monitoring conditions, the delivery unit 133 starts failure-monitoring processing.

<Step S43> The delivery unit 133 transmits the received packet to a server, and waits for a response.

<Step S44> The delivery unit 133 receives the response packet, and restarts the processing. At this stage, the delivery unit 133 is not aware of whether or not the received response packet is a response to the packet to be monitored.

<Step S45> The delivery unit 133 determines whether or not the received response packet satisfies the monitoring conditions. When yes is determined, the delivery unit 133 restarts the failure-monitoring processing, and the operation goes to step S47. When no is determined, the operation goes to step S46.

<Step S46> Since the received response packet does not satisfy the monitoring conditions, the delivery unit 133 does not perform the failure-monitoring processing, continues normal processing for delivering packets to servers, and completes the processing for delivering packets.

<Step S47> The delivery unit 133 compares the received response packet with the monitoring conditions, and determines whether or not the destination server is faulty or in operation. When the destination server is in operation, the processing of FIG. 15 is completed. When the destination server is faulty, the operation goes to step S48.

<Step S48> The delivery unit 133 sets in the failure-monitoring table information indicating that the destination server is faulty (i.e., delivery of request packets to the destination server is not allowed), and completes the processing of FIG. 15.

When the above sequence of processing is performed, it is possible to determine whether or not a subsystem containing a destination server and another server located behind the destination server is normal, by using a request packet received from a client. Thus, when failure occurs in a subsystem containing a destination server between the timings of the monitoring operations, it is possible to stop delivery of request packets to the destination server after detection of the failure by use of the request packet.

Although, in the above explanations, it is assumed that the packets are SSL encrypted and therefore the contents of the packets are unknown to the load-balancing device, it is possible to perform similar processing even when the packets are not encrypted.

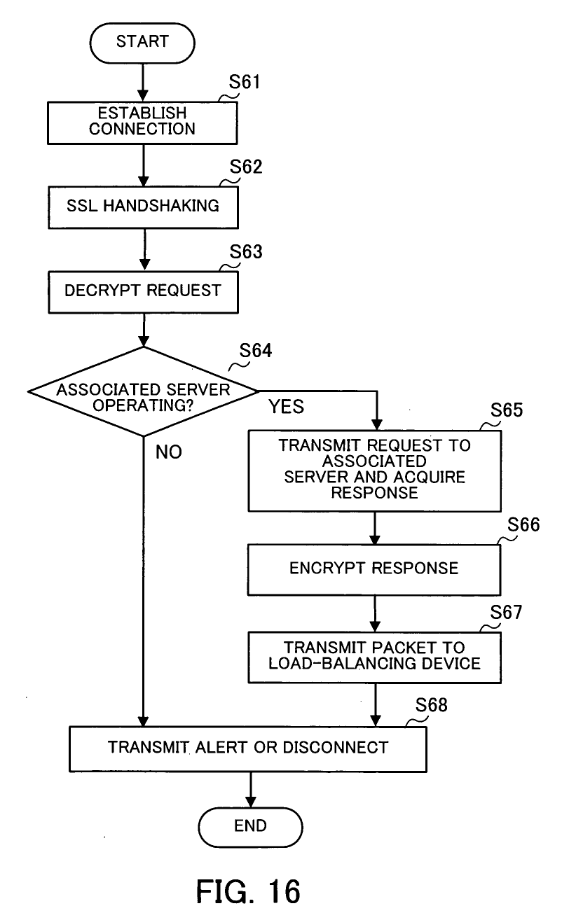

As described above, according to the second or third failure-monitoring method, the load-balancing device 10 transmits to a destination server a monitoring packet (or a packet to be monitored) which can reach another server located behind the destination server, instead transmitting a monitoring packet directly to the server located behind the destination server. Hereinbelow, a sequence of processing performed by a destination server (SSL accelerator) which sends a monitoring packet to another server located behind the destination server is explained with reference to FIG. 16, which is a flow diagram illustrating processing performed by a destination server, in the second and third failure-monitoring processes.

<Step S61> The destination server establishes a connection with a client.

<Step S62> The destination server performs SSL handshaking with the client.

<Step S63> The destination server starts application processing, and decrypts the acquired request.

<Step S64> The destination server confirms the status of the server (HTTP server) located behind the destination server. When the server (HTTP server) located behind the destination server is faulty, the operation goes to step S68. When the server (HTTP server) located behind the destination server is in operation, the operation goes to step S65.

<Step S65> Since the server (HTTP server) located behind the destination server is in operation, the destination server sends the decrypted request to the server (HTTP server) located behind the destination server, and receives a response.

<Step S66> The destination server encrypts the response.

<Step S67> The destination server sends to the load-balancing device a packet containing the encrypted response.

<Step S68> Since the server (HTTP server) located behind the destination server is faulty, the destination server transmits an Alert packet, or disconnects the connection.

When the sequence of processing illustrated in FIG. 16 is performed, the load-balancing device 10 can monitor all the servers without directly transmitting a monitoring packet to every server.

Additional Matters

The above processing functions can be realized by a computer. In this case, a program (i.e., a failure-monitoring program) describing details of processing for realizing the functions which the load-balancing device should have is provided. When the computer executes the program, the above processing functions can be realized on the computer.

The program describing the details of the processing can be stored in a recording medium which can be read by the computer. The recording medium may be a magnetic recording device, an optical disk, an optical magnetic recording medium, a semiconductor memory, or the like. The magnetic recording device may be a hard disk drive (HDD), a flexible disk (FD), a magnetic tape, or the like. The optical disk may be a DVD (Digital Versatile Disk), a DVD-RAM (Random Access Memory), a CD-ROM (Compact Disk Read Only Memory), a CD-R (Recordable)/RW (ReWritable), or the like. The optical magnetic recording medium may be an MO (Magneto-Optical Disk) or the like.

In order to put the program into the market, for example, it is possible to sell a portable recording medium such as a DVD or a CD-ROM in which the program is recorded. Alternatively, it is possible to store the program in a storage device belonging to a server computer, and transfer the program to another computer through a network.

The computer which executes the program stores the program in a storage device belonging to the computer, where the program is originally recorded in, for example, a portable recording medium. The computer reads the program from the storage device, and performs processing in accordance with the program. Alternatively, the computer may directly read the program from the portable recording medium for performing processing in accordance with the program. Further, the computer can sequentially execute processing in accordance with each portion of the program every time the portion of the program is transferred from the server computer.

As explained above, according to the present invention, failure monitoring of destination servers is performed on the basis of definition-for-monitoring information in which servers to be monitored (monitored servers), at least one monitoring procedure, and at least one criterion for determining normality are defined. Therefore, users can define details of each monitoring procedure on the basis of the environment in which the load-balancing device is used. For example, in the case where at least one server is located behind a destination server when viewed from the load-balancing device, it is possible to monitor the at least one server located behind the destination server, by defining in advance a plurality of servers which are to be monitored and are connected to the destination server including the at least one server located behind the destination server. Thus, the at least one server located behind the destination server can be monitored, and it is possible to prevent delivery of request packets from clients to a destination server behind which a faulty server exists, although such delivery can occur when the load-balancing device is not aware of the failure in the server located behind the destination server.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable storage medium storing a failure-monitoring program which makes a computer realize a load-balancing device for monitoring destination servers for failure in order to deliver request packets from clients to the destination servers and balance loads imposed on the destination servers, said load-balancing device comprising:
a definition-management unit which generates and manages for each of said destination servers definition-for-monitoring information in which one or more servers to be monitored, a monitoring procedure including a definition of a monitoring packet used in diagnosis of the one or more servers to be monitored, and, when necessary, a criterion for determining normality of the one or more servers to be monitored are defined; and
a failure-monitoring unit which transmits said monitoring packet defined in said monitoring procedure to each of said one or more servers to be monitored, in accordance with said definition-for-monitoring information, and determines that said each of the one or more servers to be monitored is faulty and delivery of one or more request packets to one of the destination servers corresponding to said each of the one or more servers to be monitored is not allowed, when no response is returned from said each of said one or more servers to be monitored, or when a response packet received from said each of the one or more servers to be monitored does not satisfy said criterion.

2. The computer-readable storage medium according to claim 1, wherein said definition-management unit defines said each of said destination servers and all of one or more servers which cooperate with said each of said destination servers to perform processing of one or more request packets, as said one or more servers to be monitored, in association with said each of said destination servers, and said failure-monitoring unit monitors said one or more servers to be monitored, by transmitting said monitoring packet to the one or more servers to be monitored, in turn.

3. The computer-readable storage medium according to claim 2, wherein said failure-monitoring unit determines that a system containing said each of said destination servers is normal and delivery of one or more request packets to said each of the destination servers to be allowed, only when all of said one or more servers to be monitored are determined to be normal.

4. The computer-readable storage medium according to claim 1, wherein said definition-management unit defines said monitoring packet in such a manner that the monitoring packet can be transmitted through said each of said destination servers, and reach one of the one or more servers to be monitored which cooperates with said each of said destination servers to perform processing of one or more request packets, said definition-management unit further defines an expected response packet which is expected to be received when said one of the one or more servers to be monitored is normal, and said failure-monitoring unit transmits said monitoring packet to said each of said destination servers, receives a response packet which is transferred through an identical path to the monitoring packet in a direction reverse to the monitoring packet from one of said one or more servers to be monitored which the monitoring packet reaches through said each of said destination servers, and determines whether or not one or more request packets are allowed to be delivered to said each of said destination servers, by comparing the response packet with the expected response packet.

5. The computer-readable storage medium according to claim 1, wherein said definition-management unit defines as a failure-monitoring packet an arbitrary packet exchanged between said clients and said destination servers or between said clients and associated servers which cooperate with said destination servers to perform processing of said request packets, and further defines a normality-determination condition which is used for determining normality of each of said destination servers and said associated servers on the basis of a response packet received in response to said failure-monitoring packet, and
said load-balancing device further comprises a delivery unit which determines whether or not each request packet from a client corresponds to said failure-monitoring packet on the basis of comparison of said each request packet and the failure-monitoring packet when said each request packet is received from the client, transmits said each request packet to a destination server, compares a status related to reception of a response packet corresponding to said each request packet from said destination server with said normality-determination condition, compares the response packet corresponding to said each request packet with said normality-determination condition when the response packet corresponding to said each request packet is received, and determines said destination server and the associated server which cooperates with said destination server to perform processing of said each request packet, to be normal when the response packet corresponding to said each request packet satisfies the normality-determination condition.

6. A failure-monitoring method for monitoring destination servers for failure in order to deliver request packets from clients to the destination servers and balance loads imposed on the destination servers, comprising the steps of:
(a) generating and storing for each of said destination servers definition-for-monitoring information in which one or more servers to be monitored, a monitoring procedure including a definition of a monitoring packet used in diagnosis of the one or more servers to be monitored, and, when necessary, a criterion for determining normality of the one or more servers to be monitored are defined;
(b) transmitting said monitoring packet defined in said monitoring procedure to each of said one or more servers to be monitored, in accordance with said definition-for-monitoring information; and
(c) determining that said each of the one or more servers to be monitored is faulty and delivery of one or more request packets to one of the destination servers corresponding to said each of the one or more servers to be monitored is not allowed, when no response is returned from said each of said one or more servers to be monitored, or when a response packet received from said each of the one or more servers to be monitored does not satisfy said criterion.

7. The failure-monitoring method according to claim 6, wherein in said definition-for-monitoring information, said each of said destination servers and all of one or more servers which cooperate with said each of said destination servers to perform processing of one or more request packets are defined as said one or more servers to be monitored, in association with said each of said destination servers, and in said step (b) said monitoring packet is transmitted in turn to the one or more servers to be monitored, for monitoring the one or more servers to be monitored.

8. The failure-monitoring method according to claim 7, wherein in said step (c) it is determined that a system containing said each of said destination servers is normal and delivery of one or more request packets to said each of the destination servers to be allowed, only when all of said one or more servers to be monitored are determined to be normal.

9. The failure-monitoring method according to claim 6, wherein said monitoring packet is defined in said definition-for-monitoring information in such a manner that the monitoring packet can be transmitted through said each of said destination servers, and reach one of the one or more servers to be monitored which cooperates with said each of said destination servers to perform processing of one or more request packets; said definition-for-monitoring information further defines an expected response packet which is expected to be received when said one of the one or more servers to be monitored is normal; in said step (b) said monitoring packet is transmitted to said each of the destination servers; and in said step (c), a response packet which is transferred through an identical path to the monitoring packet in a direction reverse to the monitoring packet from one of said one or more servers to be monitored which the monitoring packet reaches through said each of said destination servers is received, and it is determined whether or not one or more request packets are allowed to be delivered to said each of said destination servers, by comparing the response packet with the expected response packet.

10. The failure-monitoring method according to claim 6, wherein an arbitrary packet exchanged between said clients and said destination servers or between said clients and associated servers which cooperate with said destination servers to perform processing of said request packets is defined as a failure-monitoring packet in said definition-for-monitoring information; the definition-for-monitoring information further defines a normality-determination condition which is used for determining normality of each of said destination servers and said associated servers on the basis of a response packet received in response to said failure-monitoring packet; and said method further comprises the steps of (d) determining whether or not each request packet from a client corresponds to said failure-monitoring packet on the basis of comparison of said each request packet and the failure-monitoring packet when said each request packet is received from the client, (e) transmitting said each request packet to a destination server, (f) comparing a status related to reception of a response packet corresponding to said each request packet from said destination server with said normality-determination condition, (g) comparing the response packet corresponding to said each request packet with said normality-determination condition when the response packet corresponding to said each request packet is received, and (h) determining said destination server and the associated server which cooperates with said destination server to perform processing of said each request packet, to be normal when the response packet corresponding to said each request packet satisfies the normality-determination condition.

11. A load-balancing device for delivering request packets from clients to destination servers so as to balance loads imposed on the destination servers, and monitoring the destination servers for failure, comprising:
a definition-management unit which generates destination information in which said destination servers are defined as servers to which said request packets from said clients are to be delivered, generates definition-for-monitoring information for each of said destination servers, and manages the destination information and the definition-for-monitoring information, where one or more servers to be monitored, a monitoring procedure including a definition of a monitoring packet used in diagnosis of the one or more servers to be monitored, and, when necessary, a criterion for determining normality of the one or more servers to be monitored are defined in said definition-for-monitoring information;
a failure-monitoring unit which transmits said monitoring packet defined in said monitoring procedure to each of said one or more servers to be monitored, in accordance with said definition-for-monitoring information, determines that said each of the one or more servers to be monitored is faulty and delivery of one or more request packets to one of the destination servers corresponding to said each of the one or more servers to be monitored is not allowed, when no response is returned from said each of said one or more servers to be monitored, or when a response packet received from said each of the one or more servers to be monitored does not satisfy said criterion, and determines that delivery of one or more request packets to one of the destination servers corresponding to said each of the one or more servers to be monitored is allowed when the response packet received from said each of the one or more servers to be monitored satisfies said criterion; and
a delivery unit which delivers a request packet from a client to one of said destination servers to which delivery of one or more request packets is determined to be allowed, when the request packet is received from the client.

12. The load-balancing device according to claim 11, wherein said definition-management unit defines said each of said destination servers and all of one or more servers which cooperate with said each of said destination servers to perform processing of one or more request packets, as said one or more servers to be monitored, in association with said each of said destination servers, and said failure-monitoring unit monitors said one or more servers to be monitored, by transmitting said monitoring packet to the one or more servers to be monitored, in turn.

13. The load-balancing device according to claim 12, wherein said failure-monitoring unit determines that a system containing said each of said destination servers is normal and delivery of one or more request packets to said each of the destination servers to be allowed, only when all of said one or more servers to be monitored are determined to be normal.

14. The load-balancing device according to claim 11, wherein said definition-management unit defines said monitoring packet in such a manner that the monitoring packet can be transmitted through said each of said destination servers, and reach one of the one or more servers to be monitored which cooperates with said each of said destination servers to perform processing of one or more request packets, said definition-management unit further defines an expected response packet which is expected to be received when said one of the one or more servers to be monitored is normal, and said failure-monitoring unit transmits said monitoring packet to said each of said destination servers, receives a response packet which is transferred through an identical path to the monitoring packet in a direction reverse to the monitoring packet from one of said one or more servers to be monitored which the monitoring packet reaches through said each of said destination servers, and determines whether or not one or more request packets are allowed to be delivered to said each of said destination servers, by comparing the response packet with the expected response packet.

15. The load-balancing device according to claim 11, wherein said definition-management unit defines as a failure-monitoring packet an arbitrary packet exchanged between said clients and said destination servers or between said clients and associated servers which cooperate with said destination servers to perform processing of said request packets, and further defines a normality-determination condition which is used for determining normality of each of said destination servers and said associated servers on the basis of a response packet received in response to said failure-monitoring packet, and said delivery unit determines whether or not each request packet from a client corresponds to said failure-monitoring packet on the basis of comparison of said each request packet and the failure-monitoring packet when said each request packet is received from the client, transmits said each request packet to a destination server, compares a status related to reception of a response packet corresponding to said each request packet from said destination server with said normality-determination condition, compares the response packet corresponding to said each request packet with said normality-determination condition when the response packet corresponding to said each request packet is received, and determines said destination server and the associated server which cooperates with said destination server to perform processing of said each request packet, to be normal when the response packet corresponding to said each request packet satisfies the normality-determination condition.
